(19) United States
(12) Patent Application Publication
(10) Pub. No.: US 2024/0092052 A1
(43) Pub. Date: Mar. 21, 2024

(54) SEMI-CONSOLIDATED REINFORCED THERMOPLASTIC PIPE (SC-RTP) WITH COMMINGLED FIBER REINFORCEMENT

(71) Applicant: SAUDI ARABIAN OIL COMPANY, Dhahran (SA)

(72) Inventors: Abderrahim Fakiri, Dhahran (SA); Waleed Al Nasser, Ad Dammam (SA); Thibault T. Villette, Belfort (FR)

(73) Assignee: SAUDI ARABIAN OIL COMPANY, Dhahran (SA)

(21) Appl. No.: 17/932,419

(22) Filed: Sep. 15, 2022

(51) Int. Cl. B32B 1/08; B29C 63/00; B29C 63/34; B29C 70/22; B29C 70/30; B32B 5/08; B32B 5/12; B32B 7/027; B32B 27/08; B32B 27/12; B32B 37/06; B32B 37/14; B32B 37/20

(52) U.S. Cl. CPC B32B 1/08; B29C 63/0021; B29C 63/0069; B29C 63/34; B29C 70/22; B29C 70/30; B32B 5/08; B32B 5/12; B32B 7/027; B32B 27/08; B32B 27/12; B32B 37/065; B32B 37/144; B32B 37/206; B29L 2023/22

(57) ABSTRACT

A thermoplastic pipe and a method for producing it are described. The thermoplastic pipe includes a hollow inner liner layer, a semi-consolidated core comprising commingled fibers, and a shrink wrap outer layer. The commingled fibers comprise at least one thermoplastic fiber and at least one reinforcing fiber. The semi-consolidated core layer comprises a thermoplastic polymer matrix that is organized along the at least one reinforcing fiber. The method includes winding commingled fibers over the hollow inner liner layer at a designated angle to produce a core layer, covering the core layer in a heat shrinkable wrap, and heating to produce a semi-consolidated core layer. The semi-consolidated core layer comprises a thermoplastic polymer matrix that is organized along the at least one reinforcing fiber.

### BACKGROUND

In the oil and gas industry, the trend is to replace steel pipelines whenever possible with composite pipelines. Over the years, many composite piping technologies have been developed such as RTR (Reinforced Thermoset Resin), RTP (Reinforced Thermoplastic Pipe), and TCP (Thermoplastic Composite Pipe). The RTP and TCP technologies are spoolable and complement one another. RTP is made of a liner, a dry fiber reinforced core, and an outer layer. Due to the fact that the core layer is made of dry fiber, RTP attains a low to medium pressure rating, higher flexibility and smaller bending radius. On the other hand, TCP has a fully bonded structure with a core layer made of unidirectional (UD) tape in which all fibers are fully consolidated within a matrix. This allows TCP to have a high-pressure rating but less flexibility and a larger bending radius.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for producing a thermoplastic pipe. The method includes producing a hollow inner liner layer, winding commingled fibers over the hollow inner liner layer at a designated angle to produce a core layer, the commingled fibers comprising at least one thermoplastic fiber and at least one reinforcing fiber, covering the core layer in a heat shrinkable wrap, and heating one or more of the hollow inner liner layer, the core layer, and the heat shrinkable wrap at least one time to produce a semi-consolidated core layer with a thermoplastic polymer matrix organized along the at least one reinforcement fiber.

In another aspect, embodiments disclosed herein may also relate to a thermoplastic pipe. The thermoplastic pipe includes a hollow inner liner layer, a semi-consolidated core layer comprising commingled fibers that are wound around the hollow inner liner layer and heated, and a shrink wrap outer layer over the semi-consolidated core layer. The commingled fibers include at least one thermoplastic fiber and at least one reinforcing fiber, and wherein the semi-consolidated core layer comprises a thermoplastic polymer matrix that is organized along the at least one reinforcing fiber.

Other aspects and advantages of the claimed subject matter will be apparent from the following description and the appended claims.

### BRIEF DESCRIPTION OF DRAWINGS

FIG. 1 is a depiction of the operation envelope of reinforced thermoplastic pipe (RTP) and thermoplastic composite pipe (TCP) and semi-consolidated reinforced thermoplastic pipe (SC-RTP) according to one or more embodiments disclosed herein; and

FIG. 2 is an illustration of a method 200 for the production of an SC-RTP according to one or more embodiments disclosed herein.

FIG. 3 is a plot of stress-strain behavior of PVDF matrix according to one or more embodiments herein.

### DETAILED DESCRIPTION

For the purpose of this description, a single reference number will be assigned to a line as well as a stream carried in that line. Same reference numbers refer to similar components. The person skilled in the art will readily understand that while the design is illustrated referring to one or more specific combinations of features and measures many of those features and measures are functionally independent from other features and measures. Such features and measures may be equally or similarly applied independently in other embodiments or combinations.

Reinforced thermoplastic pipe (RTP), due the lack of a consolidated intermediate layer, is generally capable of withstanding pressures of up to approximately 1500 psig (about 10,342 kPa). On the other end of the scale, thermoplastic composite pipe (TCP), with a fully consolidated intermediate layer, is capable of withstanding pressure of up to approximately 10,000 psig (about 48,948 kPa). However, TCP is expensive to produce and has a larger bend radius making the use of TCP in all field applications undesirable.

Accordingly, one or more embodiments disclosed herein are directed toward a reinforced thermoplastic pipe (RTP) with a semi-consolidated (SC) core layer (SC-RTP) which may exhibit an improved pressure resistance over RTP without the large bend radius of TCP (thermoplastic consolidated pipe). The SC-RTP may include at least three layers. In one or more embodiments, the innermost of the at least three layers may include a hollow inner liner, a core layer may be wrapped around the outside of the inner liner, and a heat shrinkable wrap layer may then be placed on the outside of the core layer. Such an arrangement of layers may allow for the SC-RTP to be able to withstand pressure of up to approximately 2900 psig (about 19,995 kPa). Each of these layers will now be discussed in more detail.

The hollow inner liner may be formed from a thermoplastic through any means known to those skilled in the art. These may include, but are not limited to, extrusion or pultrusion. In one or more embodiments, the inner liner may be extruded to the target liner thickness and diameter. Extrusion may produce any thickness needed for the inner liner. In some embodiments, the molten thermoplastic may be pulled by a puller after exiting a cylindrical die prior to being cooled and solidified. The range of the thickness (outside diameter minus inside diameter) of the inner liner may have an upper limit of any of about 25 mm, about 20 mm, about 15 mm, about 10 mm, about 9 mm, or about 8 mm, and have a lower limit of any of about 0.5 mm, about 1 mm, about 2 mm, about 5 mm, about 6 mm, or about 6.5 mm. Any upper limit may be combined with any lower limit. In one or more embodiments, the outer diameter of the inner liner is in the range from about 1 inch to about 24 inches. In one or more embodiments, the outer diameter range may have an upper limit of any of 24 inches, 18 inches, or 12 inches and a lower limit of any of 1 inch, 2 inches, 4 inches, or 6 inches. The thickness of the internal liner may depend upon the desired pressure rating, the composition of the liner, the reinforcement layer properties, and other factors known to one skilled in the art.

Internal liners according to embodiments herein may be formed from natural or synthetic rubbers or other man-made polymers as known in the art. The polymers used to form the internal liners, or an innermost layer thereof, may be selected based on the properties of the material to be conveyed or handled in the spoolable composite pipes and pressure vessels according to embodiments herein. The inner layer may include a polymeric material such as a thermoplastic. In some embodiments, internal liners useful in embodiments herein may be formed from polyethylenes such as ultra-high molecular weight polyethylene (UHMWPE), high density polyethylene (HDPE), or medium density polyethylene (MDPE), or from other materials such as polyethylene of raised temperature (PE-RT), polyvinylidene fluoride (PVDF), polyamide (PA), polyphenylene sulfide (PPS), or polyketone (POK). In one or more embodiments, commingled fiber in the core may be made of similar material as the inner liner.

The hollow inner liner may be spooled on a reel after being extruded for storage before subsequent steps in the pipe manufacturing process. In other embodiments, the core layer and cover layer may be disposed on the inner liner directly, without an intermediate spooling step.

The core layer may be made of commingled fibers of thermoplastic fibers and reinforcing fibers. The thermoplastic fibers may be made of one or more thermoplastic polymers such as polyvinylidene fluoride (PVDF), polyethylene (PE), polypropylene (PP), polyaramid (PA), polyethylene terephthalate (PET), and other thermoplastic polymeric materials. In some embodiments, the thermoplastic fibers may be of a polymer similar to the inner liner material. In one or more embodiments, the hollow inner liner may have a higher melting point as compared to the thermoplastic fibers. The reinforcing fibers may be made of materials that may include, but are not limited to, carbon fiber, glass fiber, aramid fiber, or basalt fiber. Commingled fibers may have diameters ranging from 5 microns to 1000 microns. The diameters may have an upper limit of any of 1000 microns, 800 microns, or 600 microns and a lower limit of any of 5 microns, 10 microns, 50 microns, 100 microns, 200 microns, or 400 microns, where any upper limit may be combined with any lower limit.

Because the commingled fibers are interspersed together, the thermoplastic fibers may wet the reinforcing fibers when melted. The thermoplastic fibers may be selected to be compatible with the liner material to have a good bonding and strong interface with it. The thermoplastic polymer may have a melting point not exceeding the melting point of the liner and shrink wrap outer layer. This lower melting point may allow the thermoplastic polymer to melt and flow without damaging the integrity of the liner and shrink wrap outer layer. The melting point of the thermoplastic polymer may have a melting point that is at least 5° C. below that of the shrink wrap layer or the inner liner. The thermoplastic polymer may have a melting point that is at least 5° C.-50° C. below that of the shrink wrap layer and the inner liner in order to promote bonding upon melting and subsequent cooling without negatively impacting the other layers during manufacture. The thermoplastic polymer may be selected to have a melting point that is greater than that of the end use temperature to prevent melting during operation.

In one or more embodiments, the thermoplastic fibers may be present in a volume fraction of the core lay that may range from about 1 vol % to about 75 vol %, for example with a lower limit of any of 1 vol %, 10 vol %, or 20 vol % to an upper limit of any of 50 vol %, 60 vol %, or 75 vol %, where any lower limit may be used in combination with any upper limit.

The commingled fibers may be tightly wound around the inner liner using any method apparent to one of ordinary skill in the art. The commingled fibers may be wound in one or more layers at one or more designated angles. In one or more embodiments, the core layer may have a two-layer wrapping. The winding angle may range from about 1 to about 89 degrees, for example with a lower limit of any of about 1 degree, about 10 degrees, about 20 degrees, about 40 degrees, about 45 degrees, or about 50 degrees to an upper limit of any of about 60 degrees, about 65 degrees, about 70 degrees, about 80 degrees, or about 89 degrees, where any lower limit may be used in combination with any upper limit. The winding angle may be measured clockwise or counter-clockwise from the pipe axis. The commingled fibers may be wrapped at the same or different winding angle. In some embodiments, the commingled fibers may be wrapped counter to each other so that the opposing forces of the final semi-consolidated fibers sufficiently support the inner liner and provide the desired reinforcement. The commingled fibers may be wound around the inner liner to a thickness in the range of 4 mm to 25 mm for example with a lower limit of any of about 4 mm, about 5 mm, about 7 mm, or about 10 mm, and an upper limit of any of about 25 mm, about 22 mm, or about 20 mm, where any lower limit may be used in combination with any upper limit.

In one or more embodiments, after the core layer is wrapped around the hollow inner liner layer the core layer may be covered with a heat shrinkable wrap that may be tightly wound over the core layer. This may be performed using various techniques such as winding or wrapping processes. The material for the heat shrinkable wrap may have a good heat resistance to withstand heat when the thermoplastic polymer fibers in the core layer are melting. The shrink wrap outer layer material and thermoplastic fiber material in the core layer may be selected to so that they are compatible with one another to facilitate bonding between the core layer and the heat shrinkable wrap. The melting point of the heat shrinkable wrap may be greater than that of the thermoplastic polymer in some embodiments to allow for consolidation of the core layer without the shrink wrap outer layer melting.

In one or more embodiments, while or after wrapping the heat shrinkable film, the pipe structure may pass through a heating station (inline or offline) to consolidate the core layer. The heating station can be set at a temperature that is at least sufficient to melt the thermoplastic polymer fiber in the core layer while the top wrap shrinks to push the molten polymer into the reinforcing fibers. Sufficient heat must be applied to melt the thermoplastic polymer fiber in the core layer without damaging the shrink wrap and the liner. In one or more embodiments, IR or convection heaters may be used for these purposes. The pipe structure may be heated at least one time. The level of consolidation in the core layer can be tailored by altering the fiber volume fractions, the heat intensity, the heating station length and size, line speed, shrink wrap material type, and thickness depending on the final pressure requirement of the pipe. The final degree of consolidation may range from about 0.01% to about 99.99% for example with a lower limit of any of 0.01%, 10%, 20%, 30%, or 40% to an upper limit of any of 60%, 70%, 80%, 90%, or 99.99% where any lower limit may be used in combination with any upper limit. In some embodiments, the end product is a spoolable composite pipe with at least a liner, semi-consolidated core layer and a shrink wrap outer layer. If more consolidation is needed, post-heating may take place. The semi-consolidated core layer comprises a thermoplastic polymer matrix organized along the reinforcement fibers.

During the heating process, the heat source needs to provide sufficient heat to melt thermoplastic fibers in the commingled core layer, provide sufficient heat to radially shrink the outer wrap and pushes the melt inside the reinforcing fibers to provide fiber wet-out and some sort of consolidation, and have minimum or no impact on the inner liner.

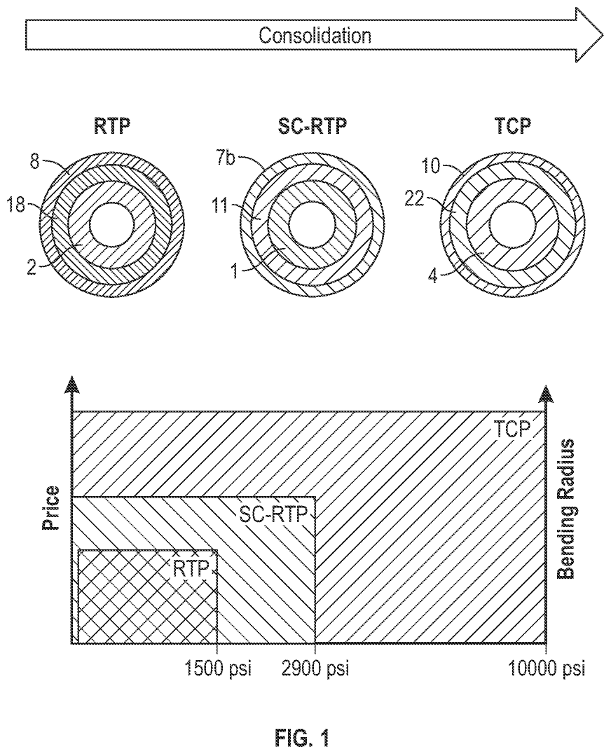

Referring now to the figures, FIG. 1 is a depiction of the operation envelope of RTP and TCP composite pipes. RTP, having a jacket layer 8 extruded over the core layer, a dry fiber reinforced core 18 and an inner liner 2, has a pressure rating of less than 1500 psig (about 10,342 kPa) and a small bending radius. TCP, having an outer layer 10 extruded over the core layer, a core layer comprising a fully-bonded structure 22, and an inner liner 4, has a pressure rating of up to 10,000 psig (about 68,947 kPa) and a large bending radius. SC-RTP, having the previously described shrink wrap outer layer 7, semi-consolidated core 11, and inner liner 1 according to embodiments herein have been found to have a pressure rating of up to 2900 psig (about 19,995 kPa) and a bending radius between RTP and TCP. In one or more embodiments SC-RTP may have a reduced bending radius with respect to TCP, while allowing for an increased pressure resistance over RTP.

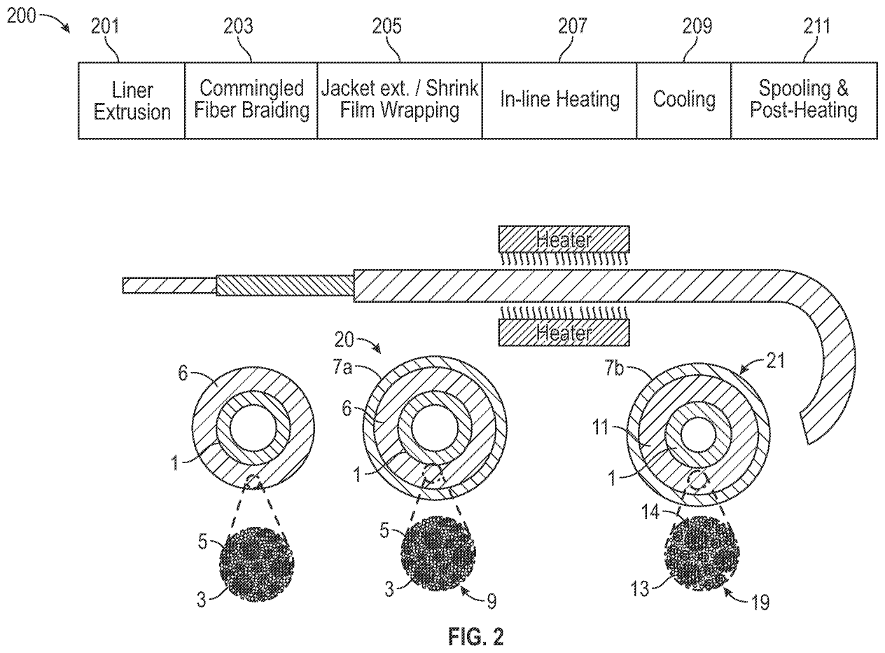

FIG. 2 is an illustration of a method 200 for the production of an SC-RTP according to one or more embodiments disclosed herein. Inner liner 1 may be produced via any method apparent to one of ordinary skilled in the art, such as extrusion. In one or more embodiments, the inner liner 1 may be produced by an extrusion process 201. Commingled dry yarn 9 comprising thermoplastic fibers 5 and reinforcing fibers 3 may be wrapped 203 around the inner liner 1 to produce an unconsolidated core 6 comprising the commingled dry yarn 9. Unheated shrink film 7a may then be wrapped 205 around the unconsolidated core 6, producing an unconsolidated pipe 20, before being heated 207 to produce a semi-consolidated core 11. The system 21 after heating 207 includes an inner liner 1, a core 11 comprising semi-consolidated yarn 19 made up of wetted reinforcing fibers 13 and molten thermoplastic 14, and a heated shrink film wrapping 7b. In some embodiments, the heating 207 causes the wrap to shrink, melts the thermoplastic fibers 5, producing molten thermoplastic 14, and as the wrap shrinks it pushes the molten thermoplastic 14 into the reinforcing fibers 3, producing wetted reinforcing fibers 13. The piping can then be cooled 209, before being post-heated if desired and spooled 211. In one or more embodiments, the final SC-RTP system 21 includes an inner liner 1, a semi-consolidated core 11 comprising wetted reinforcing fibers 13 that comprise thermoplastic, thermoplastic 14 and a shrink film wrapping 7b.

### Examples

A numerical modeling study was conducted where the RTP, SC-RTP, and TCP were compared using PVDF (polyvinylidene fluoride) matrix (used for high temperature) and glass fibers as the constituents with the assumption that PVDF fiber is assembled along the glass fibers for optimum load transfer. Three structures were developed by altering the volume space not occupied by glass fiber (void space) from 0% (all matrix TCP), 25% void (almost half void and matrix SC-RTP) and 47.7% (all void, RTP) as shown in Table 1.

TABLE 1
Three structures at different void contents
for performance simulation comparison.

| | TCP | SC-RTP | RTP |
|---|---|---|---|
| Matrix content (vol.) | 47.7 | 22.7 | 0 |
| Fiber content (vol.) | 52.3 | 52.3 | 52.3 |
| Void content (vol.) | 0 | 25.0 | 47.7 |

A representative volume element comprising a polymer matrix and glass fibers was constructed by two glass fiber plies oriented at +/−55° angle with respect to the pipe axis.

Following the design of the representative volume elements, a mesh was applied to the model and the system was subjected to a strain-driven uniaxial loading in the hoop direction to simulate the local response of the pipe under internal pressure. The loading imposed consisted of 3% strain in the hoop direction of the pipe. The representative volume element was left free in the longitudinal direction.

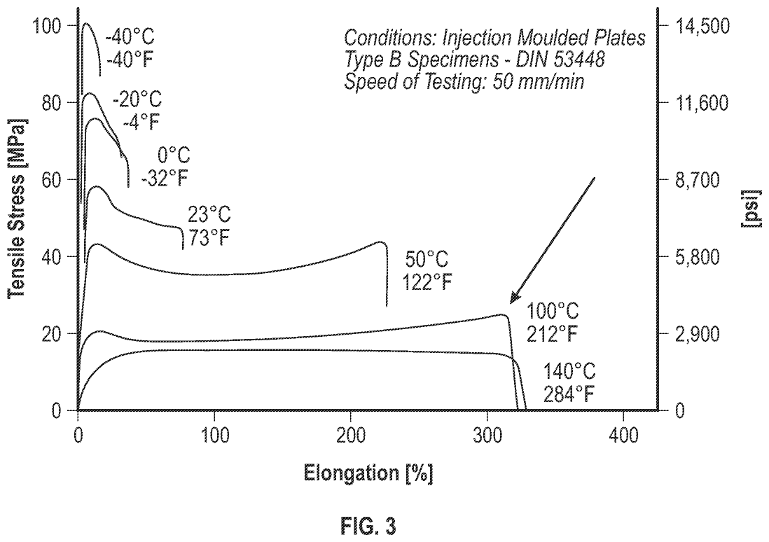

The material properties utilized in the finite element analysis to model the polymer matrix were extracted from a datasheet published by the material supplier. The polymer matrix material used in the analysis was a PVDF material, grade Solef® from the company SOLVAY. The selected temperature is 100° C. in order to simulate conditions close to real service conditions experienced in O&G transportation. The stress-strain response of the polymer matrix is presented in FIG. 3. An elasto-plastic material model was used for the polymer matrix with a Young's modulus of 800 MPa, a maximum strength of 20 MPa, and an ultimate strain equal to 300%. An elastic material model was used for the glass fiber using generic data from the literature, with a Young's modulus of 70,000 MPa and a strength of 1,450 MPa.

After the analysis was run, the post-processing consisted of analyzing and comparing the maximum effective strain and effective stress in the polymer matrix and at the composite scale. Finally, the stiffness of the resulting composite was estimated in the hoop direction for each variant of the composite. The simulation results are shown in Table 2. The maximum matrix strain is a good indicator of how much strain is carried by the matrix before reaching its failure strain, 300% ultimate matrix strain (UMS) for this SOLEF® PVDF (polyvinylidene fluoride) at 100° C. For TCP, the matrix reached 47% of the UMS while for the SC-RTP structure the matrix reached 59% of the UMS which indicates the structure can carry the prescribed load without deforming significantly more while saving 50% of the matrix material as compared to TCP.

TABLE 2
Simulation performance results of the three structures

| | | 50% | 0% |
|---|---|---|---|
| | Fully | consolidation | consolidation |
| | consolidated | organized matrix | structure (no |
| | structure, TCP | placement | matrix), RTP |
| Maximum matrix | 140% (47% of | 177% (59% of | N/A |
| strain (%) | strain failure) | strain failure) | |

Unless defined otherwise, all technical and scientific terms used have the same meaning as commonly understood by one of ordinary skill in the art to which these systems, apparatuses, methods, processes, and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for producing a thermoplastic pipe comprising:
producing a hollow inner liner layer;
winding commingled fibers over the hollow inner liner layer at a designated angle to produce a core layer, the commingled fibers comprising at least one thermoplastic fiber and at least one reinforcing fiber;
covering the core layer in a heat shrinkable wrap; and
heating one or more of the hollow inner liner layer, the core layer, and the heat shrinkable wrap at least one time to produce a semi-consolidated core layer with a thermoplastic polymer matrix organized along the at least one reinforcement fiber.

2. The method of claim 1, wherein the heating comprises heating the core layer to a temperature greater than the melting point of the at least one thermoplastic fiber and less than the melting point of the heat shrinkable wrap.

3. The method of claim 1, wherein the final degree of consolidation of the semi-consolidated core layer is between about 0.01% and about 99.99%.

4. The method of claim 1, further comprising post-heating one or more of the hollow inner liner layer, the core layer, and the heat shrinkable wrap.

5. The method of claim 1, wherein the thermoplastic fiber comprises at least one polymer selected from the group consisting of: polyvinylidene fluoride, polyethylene, polypropylene, polyaramid, polyethylene terephthalate, and a combination thereof.

6. The method of claim 1, wherein the hollow inner liner layer comprises a thermoplastic.

7. The method of claim 1, wherein the at least one reinforcing fiber comprises at least one material selected from the group consisting of: carbon fiber, glass fiber, aramid fiber, and basalt fiber.

8. The method of claim 1, wherein the fiber volume fraction of the thermoplastic fibers in the core layer is in the range from 1% to 75%.

9. The method of claim 1, wherein the winding is performed at an angle measured from a pipe axis in the range from 1 to 89 degrees in a clockwise or a counter-clockwise direction.

10. The method of claim 1, wherein the producing the hollow inner liner layer comprises:
extruding the hollow inner liner layer.

11. The method of claim 10, wherein extruding comprises passing a molten thermoplastic through a cylindrical die and subsequently pulling the molten thermoplastic.

12. A thermoplastic pipe comprising:
a hollow inner liner layer;
a semi-consolidated core layer comprising commingled fibers that are wound around the hollow inner liner layer and heated; and
a shrink wrap outer layer over the semi-consolidated core layer,
wherein the commingled fibers comprise at least one thermoplastic fiber and at least one reinforcing fiber, and
wherein the semi-consolidated core layer comprises a thermoplastic polymer matrix that is organized along the at least one reinforcing fiber.

13. The thermoplastic pipe of claim 12, wherein the at least one thermoplastic fiber comprises at least one polymer selected from the group consisting of: polyvinylidene fluoride, polyethylene, polypropylene, polyaramid, polyethylene terephthalate, and a combination thereof.

14. The thermoplastic pipe of claim 12, wherein the hollow inner liner layer has a thickness from 0.5 mm to 25 mm.

15. The thermoplastic pipe of claim 12, wherein the hollow inner liner layer has an outer diameter from 1 inch to 24 inches.

16. The thermoplastic pipe of claim 12, wherein the hollow inner liner layer comprises a thermoplastic.

17. The thermoplastic pipe of claim 12, wherein the at least one reinforcing fiber comprises at least one material selected from the group consisting of: carbon fiber, glass fiber, aramid fiber, and basalt fiber.

18. The thermoplastic pipe of claim 12, wherein the fiber volume fraction of the thermoplastic fibers in the semi-consolidated core layer is in the range from 1% to 75%.

19. The thermoplastic pipe of claim 12, wherein the commingled fiber is wound around the hollow inner liner layer at an angle from 1 to 89 degrees in a clockwise or a counter-clockwise direction measured from a pipe axis.
